(19) United States
(12) Patent Application Publication
(10) Pub. No.: US 2014/0064736 A1
(43) Pub. Date: Mar. 6, 2014

(54) INFORMATION PROCESSING APPARATUS, INFORMATION PROCESSING SYSTEM, INFORMATION PROCESSING METHOD, AND PROGRAM THEREFOR

(71) Applicant: Sony Corporation, Tokyo (JP)

(72) Inventor: Yoshihiro MANABE, Tokyo (JP)

(21) Appl. No.: 13/934,641

(22) Filed: Jul. 3, 2013

(30) Foreign Application Priority Data
Sep. 5, 2012 (JP) 2012194991

(51) Int. Cl. G08C 23/04

(52) U.S. Cl. CPC G08C 23/04
USPC 398/107

(57) ABSTRACT

An information processing apparatus including: a light-receiving section capable of receiving an optical signal emitted from another apparatus; a controller capable of acquiring identification information for identifying the another apparatus on a network based on the received optical signal; and a communication section capable of establishing a connection with the another apparatus based on the acquired identification information.

### BACKGROUND

The present disclosure relates to an information processing apparatus that includes a camera or a light-receiving element and is capable of communicating with another information processing apparatus, an information processing system including the information processing apparatus, an information processing method used in the information processing apparatus, and a program therefor.

From the past, when an information processing apparatus is to communicate with a specific apparatus in an environment where a plurality of communication apparatuses exist on a network, a user checks information such as a MAC address, an IP address, and an apparatus model number on a list of apparatuses and selects an apparatus to be a communication counterpart based on the information.

### SUMMARY

However, the information such as a MAC address is difficult to be understood by a general user, and thus the user finds it difficult to smoothly select a communication counterpart.

In view of the circumstances as described above, there is a need for an information processing apparatus, an information processing system, an information processing method, and a program therefor with which a user can easily select an apparatus to be a communication counterpart without requiring complicated operations.

According to an embodiment of the present disclosure, there is provided an information processing apparatus including a light-receiving section, a controller, and a communication section. The light-receiving section is capable of receiving an optical signal emitted from another apparatus. The controller is capable of acquiring identification information for identifying the another apparatus on a network based on the received optical signal. The communication section is capable of establishing a connection with the another apparatus based on the acquired identification information.

With this structure, the information processing apparatus can easily designate an apparatus to be a communication counterpart by acquiring the identification information based on the optical signal emitted from the another apparatus.

The light-receiving section may be capable of photographing the another apparatus. In this case, the information processing apparatus may further include a display section capable of displaying a photographed image of the another apparatus, and the controller may be capable of acquiring the identification information when the image of the another apparatus is displayed on the display section.

With this structure, the information processing apparatus can acquire the identification information of the another apparatus as the user directs the light-receiving section to the another apparatus so as to display an image of the another apparatus on the display section. Therefore, the user can establish a connection with the another apparatus by an extremely simple operation of directing the light-receiving section to the another apparatus.

The another apparatus may be capable of displaying a predetermined image corresponding to the identification information as the optical signal. In this case, the light-receiving section may be capable of photographing the image, and the controller may be capable of acquiring the identification information from the photographed image.

With this structure, the information processing apparatus can establish a connection with the another apparatus based on the predetermined image displayed on the another apparatus. The predetermined image used herein is, for example, a figure, a letter, and a pattern, though not limited thereto.

The light-receiving section may be capable of receiving at least a part of the image of the another apparatus as the optical signal. In this case, the controller may be capable of acquiring the identification information of the another apparatus based on a result of object recognition processing carried out on at least the part of the image of the another apparatus.

With this structure, the information processing apparatus can acquire the identification information from the shape of the another apparatus itself by the object recognition processing. The object recognition processing used herein may be executed by the controller itself or a server on the network. In the latter case, the controller transmits the image of the another apparatus to the server on the network via the communication section and receives the result of the object recognition processing on the server via the communication section.

The information processing apparatus may further include a transmission section capable of transmitting a request signal for requesting the another apparatus to emit the optical signal.

With this structure, the information processing apparatus can acquire the identification information by causing the another apparatus to emit an optical signal by the transmission of the request signal. Here, the transmission section may be an infrared ray transmission section capable of transmitting, as infrared light, a request signal to an infrared ray receiving section included in the another apparatus, for example, or may be a network interface capable of transmitting the request signal to the another apparatus via a LAN.

The information processing apparatus may further include an operation reception section capable of receiving, when images of a plurality of another apparatuses are displayed on the display section, an operation of selecting any one of the images of the plurality of another apparatuses. In this case, the controller may be capable of acquiring the identification information of an apparatus corresponding to the image selected by the operation.

With this structure, the user can easily designate an apparatus to be a communication counterpart by selecting any one of the plurality of apparatuses even when images of the plurality of apparatuses are taken by the light-receiving section. Here, the selection operation is, for example, a touch operation. In this case, the display section may be integrated with a touch panel.

The information processing apparatus may further include a storage that stores a content. In this case, the controller may be capable of controlling the communication section to transmit the content to the another apparatus with which the connection has been established.

With this structure, the information processing apparatus can designate the another apparatus as a content transmission target and transmit a content thereto without requiring the user to perform complicated operations.

The light-receiving section may be capable of receiving a first optical signal emitted from a first apparatus and a second optical signal emitted from a second apparatus different from the first apparatus. In this case, the controller may be capable of acquiring first identification information of the first apparatus based on the first optical signal and second identification information of the second apparatus based on the second optical signal. Also in this case, the communication section may be capable of establishing a connection with the first apparatus based on the first identification information and a connection with the second apparatus based on the second identification information, and transmitting a setting change request to change an access setting between the first apparatus and the second apparatus to one of the first apparatus and the second apparatus.

With this structure, the information processing apparatus can acquire the identification information from the first apparatus and the second apparatus and cause, based on the identification information, the first or second apparatus to change the access setting between the first and second apparatuses.

The light-receiving section may be capable of receiving a first optical signal emitted from a first apparatus and a second optical signal emitted from a second apparatus different from the first apparatus. In this case, the controller may be capable of acquiring first identification information of the first apparatus based on the first optical signal and second identification information of the second apparatus based on the second optical signal. Also in this case, the communication section may be capable of establishing a connection with the first apparatus based on the first identification information and a connection with the second apparatus based on the second identification information, and transmitting a setting change request to change an access setting between the first apparatus and the second apparatus to a server on the network that manages the access setting.

With this structure, the information processing apparatus can acquire the identification information from the first apparatus and the second apparatus and cause, based on the identification information, the server to change the access setting between the first apparatus and the second apparatus.

The optical signal may be emitted as infrared light, and the light-receiving section may be capable of receiving the infrared light.

With this structure, since the information processing apparatus can receive the optical signal emitted as infrared light, by the another apparatus emitting the optical signal as infrared light, it is possible to prevent light from entering an eye of the user, which is annoying.

According to another embodiment of the present disclosure, there is provided an information processing system including a first apparatus and a second apparatus.

The first apparatus includes a light-receiving section, a controller, and a first communication section. The light-receiving section is capable of receiving an optical signal emitted from the second apparatus. The controller is capable of acquiring identification information for identifying the second apparatus on a network based on the received optical signal. The first communication section is capable of transmitting a connection establishment request to the second apparatus based on the acquired identification information.

The second apparatus includes a light-emitting section that emits the optical signal, and a second communication section capable of establishing a connection with the first apparatus in response to the transmitted connection establishment request.

According to another embodiment of the present disclosure, there is provided an information processing method, including: receiving an optical signal emitted from another apparatus; acquiring identification information for identifying the another apparatus on a network based on the received optical signal; and establishing a connection with the another apparatus based on the acquired identification information.

According to another embodiment of the present disclosure, there is provided a program that causes an information processing apparatus to execute the steps of: receiving an optical signal emitted from another apparatus; acquiring identification information for identifying the another apparatus on a network based on the received optical signal; and establishing a connection with the another apparatus based on the acquired identification information.

As described above, according to the embodiments of the present disclosure, an apparatus to be a communication counterpart can be easily designated without requiring the user to perform complicated operations.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing an outline of a system according to a first embodiment of the present disclosure;

FIG. 2 is a block diagram showing a hardware structure of a smartphone in the system;

FIG. 3 is a block diagram showing software module structures of the smartphone and a TV in the system;

FIG. 4 is a sequence diagram showing a flow of operations of the smartphone and the TV in the system;

FIG. 5 is a diagram showing a state where the smartphone reads ID information displayed on a display section of the TV;

FIG. 6 is a diagram showing an outline of a system according to a second embodiment of the present disclosure;

FIG. 7 is a block diagram showing software module structures of a smartphone, a TV, and a server according to the second embodiment;

FIG. 8 is a sequence diagram showing a flow of operations of the smartphone, the TV, and the server according to the second embodiment;

FIG. 9 is a sequence diagram showing a flow of operations of a smartphone, a TV, and a BD recorder according to a third embodiment of the present disclosure; and

FIG. 10 is a sequence diagram showing a flow of operations of a smartphone, a TV, a BD recorder, and a server according to a fourth embodiment of the present disclosure.

### DETAILED DESCRIPTION OF EMBODIMENTS

Hereinafter, embodiments of the present disclosure will be described with reference to the drawings.

### First Embodiment

First, a first embodiment of the present disclosure will be described.

### (Outline of System)

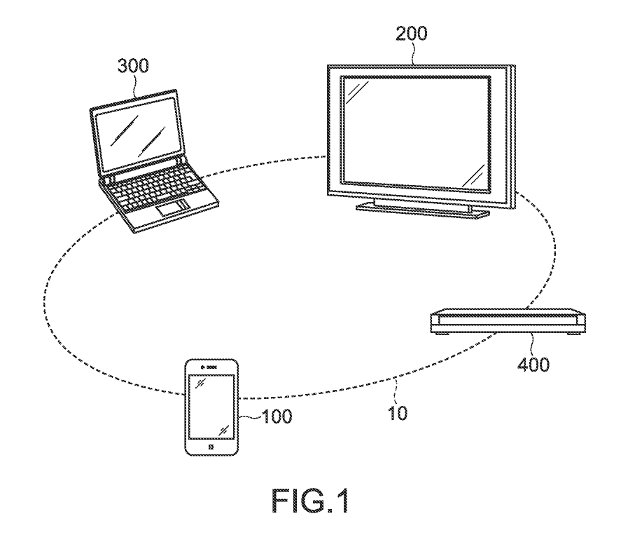

FIG. 1 is a diagram showing an outline of a system according to this embodiment.

As shown in the figure, the system is constituted of a plurality of information processing apparatuses such as a smartphone 100, a TV 200, a PC 300, and a BD (Blu-ray disc) recorder 400. Those apparatuses form a network such as a home network 10.

The home network 10 is a network conforming to, for example, a DLNA (Digital Living Network Alliance) standard. On the home network 10, the apparatuses may each function as a DMR (Digital Media Renderer), a DMS (Digital Media Server), a DMP (Digital Media Player), and a DMC (Digital Media Controller) in the DLNA. In this embodiment, the smartphone 100 mainly functions as the DMC or the DMS, the PC 300 and the BD recorder 400 mainly function as the DMS, and the TV 200 mainly functions as the DMP or the DMR.

For example, the smartphone 100 as the DMS is capable of instructing the TV 200 as the DMP to acquire and reproduce its own content. The smartphone 100 as the DMC is also capable of instructing the TV 200 as the DMP to acquire and reproduce a content stored in the BD recorder 400 as the DMS.

Although a total of four information processing apparatuses are shown in the figure, the number of information processing apparatuses to be connected to the home network 10 is not limited thereto, and the number may be 3 or less or 5 or more.

When the smartphone 100 functions as the DMC, a user thereof needs to designate an apparatus to be the DMP when wishing to reproduce a content stored in the smartphone 100 or another apparatus on the home network 10 by the apparatus as the DMP. Although details will be given later, in this embodiment, by using a camera of the smartphone 100 in designating the apparatus, processing is simplified.

### (Hardware Structure of Smartphone)

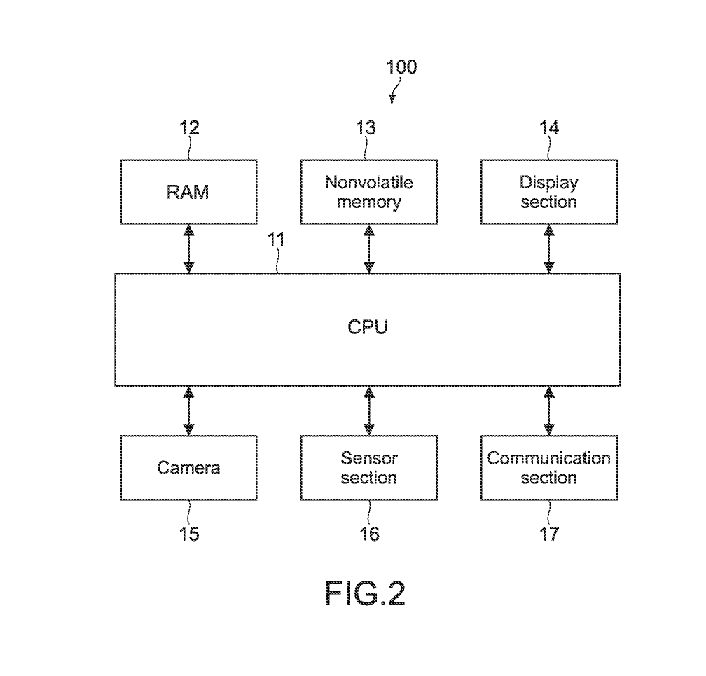

FIG. 2 is a block diagram showing a hardware structure of the smartphone 100.

As shown in the figure, the smartphone 100 includes a CPU (Central Processing Unit) 11, a RAM (Random Access Memory) 12, a nonvolatile memory 13, a display section 14, a camera 15, a sensor section 16, and a communication section 17.

The CPU 11 accesses the RAM 12 or the like as necessary and collectively controls the overall blocks of the smartphone 100 while carrying out various types of operational processing. The RAM 12 is used as a working area of the CPU 11 and temporarily stores various applications being executed and various types of data being processed.

The nonvolatile memory 13 is, for example, a flash memory or a ROM (Read Only Memory), and fixedly stores firmware such as an OS to be executed by the CPU 11, programs (applications), and various parameters.

Further, the nonvolatile memory 13 stores still image data (e.g., image data of another apparatus) taken by the camera 15 and ID data (to be described later) of another apparatuses acquired from those images.

The display section 14 is, for example, an LCD (Liquid Crystal Display) or an OELD (Organic Electro-Luminescence Display), and displays various menus, GUIs of applications, and the like. Typically, the display section 14 is integrated with a touch panel and is capable of accepting a touch operation of a user. The display section 14 also functions as a finder of the camera 15.

The camera 15 takes a still image (photograph) and a moving image by an image pickup device such as a CMOS (Complementary Metal Oxide Semiconductor) sensor and a CCD (Charge Coupled Device) sensor.

The sensor section 16 is constituted of various sensors and detects positional information (latitude/longitude information), directional information, and physical information (acceleration/gravity information) of the smartphone 100, and the like.

The communication section 17 communicates with the another apparatuses via the home network 10 according to the DLNA standard, for example. The communication section 17 is also connectable with a wireless LAN (e.g., IEEE802.11) such as WiFi (Wireless Fidelity) and 3G and 4G networks for mobile communication.

Although not shown, hardware structures of the another apparatuses such as the TV 200, the PC 300, and the BD recorder 400 are generally the same as that of the smartphone 100 except that those apparatuses do not include a camera. Further, in those apparatuses, an HDD (Hard Disk Drive) may be used as the storage in place of the nonvolatile memory.

### (Module Structures of Smartphone and TV)

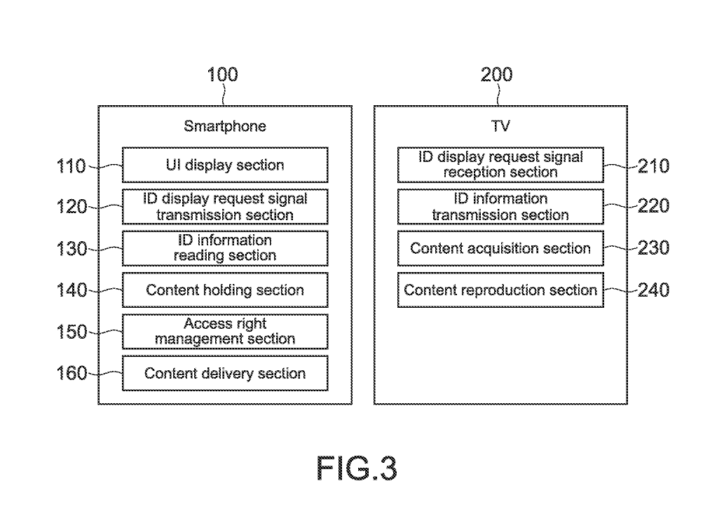

FIG. 3 is a block diagram showing software module structures of the smartphone 100 and the TV 200.

### (Modules of Smartphone)

As shown in the figure, the smartphone 100 includes a UI (User Interface) display section 110, an ID display request signal transmission section 120, an ID information reading section 130, a content holding section 140, an access right management section 150, and a content delivery section 160.

The UI display section 110 displays on the display section 14, in addition to UIs such as a menu screen for executing various functions of the smartphone 100 and various applications, UIs required in communication processing with the another apparatuses on the home network 10, and accepts operations of the user.

The ID display request signal transmission section 120 transmits, to the apparatus as a communication counterpart, an ID display request signal that requests the apparatus to display ID information for identifying the apparatus as an optical signal. The ID display request signal transmission section 120 may be assumed by the communication section 17 or may be realized by an infrared ray transmission section provided additionally in the smartphone 100, for example.

The ID information reading section 130 reads an ID from the optical signal emitted from the apparatus to be the communication counterpart in response to the ID display request signal.

The content holding section 140 stores contents such as video data and still image data.

The access right management section 150 manages information on access rights (acceptable/unacceptable) among the apparatuses in the home network 10.

The content delivery section 160 delivers a content stored in the content holding section 140 in response to a request from another apparatus (e.g., TV 200) with which a connection has been established based on the ID.

### (Modules of TV)

The TV 200 includes software modules of an ID display request signal reception section 210, an ID information transmission section 220, a content acquisition section 230, and a content reproduction section 240.

The ID display request signal reception section 210 receives the ID display request signal transmitted from the ID display request signal transmission section 120 of the smartphone 100 and hands it over to the ID information transmission section 220.

The ID information transmission section 220 transmits (displays) ID information as the optical signal in response to the ID display request signal. In this embodiment, the ID information is displayed as a graphic image on a display section of the TV 200, for example, though not limited thereto.

The content acquisition section 230 acquires, after a connection with the smartphone 100 is established by reading the ID information, the content stored in the smartphone 100 via the home network 10.

The content reproduction section 240 reproduces the content acquired by the content acquisition section 230.

In the figure, the modules explained as being included in the TV 200 are modules that all the apparatuses functioning as the DMP include in this embodiment and are not only included in the TV 200.

### (System Operation)

Next, an operation of the system structured as described above will be described while mainly focusing on the operations of the smartphone 100 and the TV 200. In this and other embodiments, the operations of the smartphone 100 and the TV 200 are carried out by the CPU in cooperation with the software modules executed under control of the CPU.

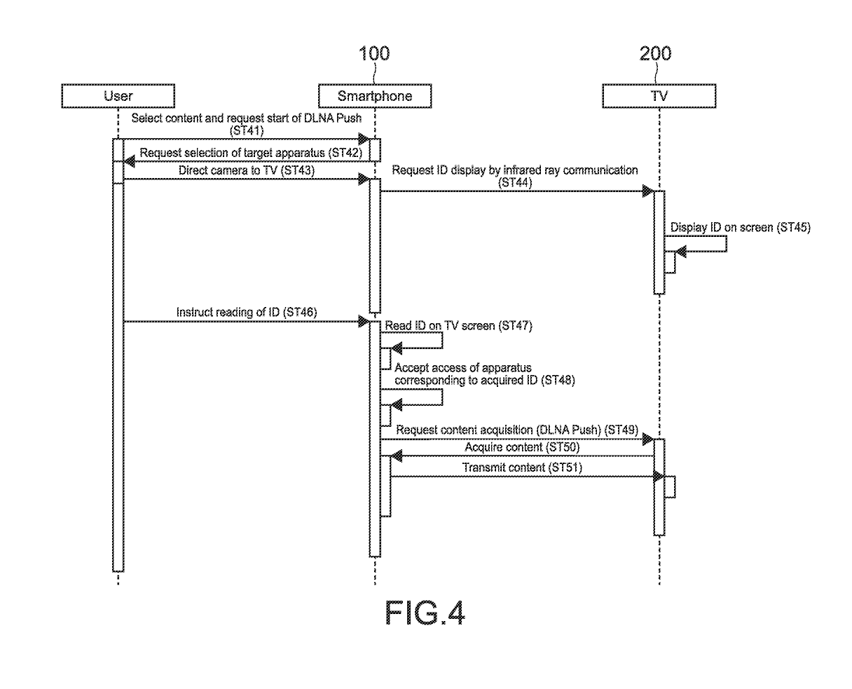

FIG. 4 is a sequence diagram showing a flow of the operations of the smartphone 100 and the TV 200 according to this embodiment.

The figure shows an example where the smartphone 100 establishes a connection with the TV 200 and delivers a specific content stored in itself to the TV 200 by DLNA Push to reproduce the content.

As shown in the figure, a user of the smartphone 100 first inputs operations of selecting a content and requesting a start of DLNA Push via the UI display section 110 (Step 41).

Subsequently, the ID display request signal transmission section 120 of the smartphone 100 displays a screen (e.g., message) for prompting the user to select a content delivery target apparatus on the display section 14 (Step 42).

In response to the selection request, the user directs the camera 15 to the TV 200 so that the TV 200 is displayed on the display section 14 (Step 43). At this time, as the UI of the display section 14, an interface for confirming the user whether the selection processing has been completed in response to the selection request (e.g., OK/cancel button) is displayed and upon directing the camera to the TV 200, presses the OK button.

Upon completing the selection of the apparatus, the ID display request signal transmission section 120 transmits an ID display request signal to the TV 200 by infrared ray communication (Step 44).

The ID display request signal reception section 210 of the TV 200 receives the ID display request signal from the smartphone 100 and hands it over to the ID information transmission section 220. The ID information transmission section 220 displays a figure as the ID information on the display section of the TV 200 (Step 45). Associated to the figure is information with which the TV 200 can be uniquely identified on the home network 10, such as an IP address, a MAC address, and a model number.

Upon display of the figure, the user inputs an ID reading instruction operation via the UI display section 110 (Step 46). In response to the operation, the ID information reading section 130 of the smartphone 100 reads the ID information from the figure (Step 47). Here, the ID information reading section 130 may read the ID information without waiting for the ID reading instruction in Step 46.

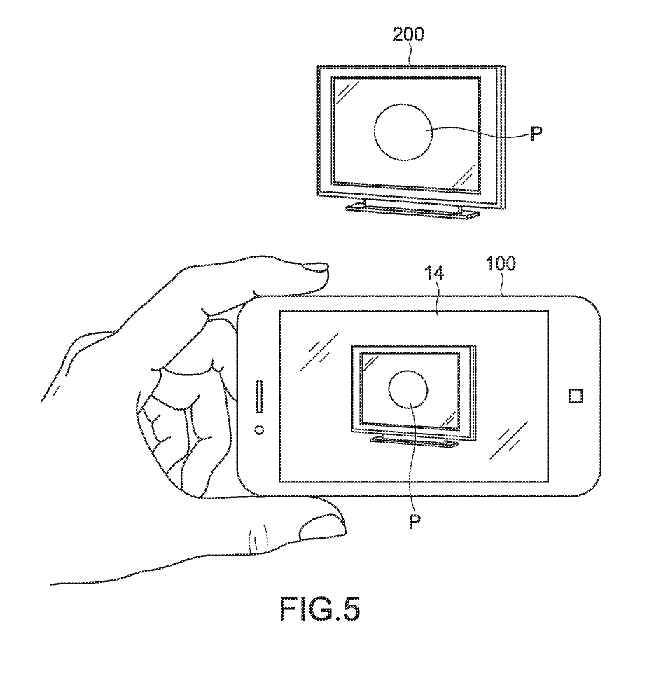

FIG. 5 is a diagram showing a state where the smartphone 100 reads the ID information displayed on the display section of the TV 200.

As shown in the figure, a figure P (e.g., circle) is displayed on the display section of the TV 200, and the ID information reading section 130 of the smartphone 100 reads the ID information of the relevant TV 200 from the figure P. The ID information reading section 130 stores a table that defines in advance a correspondence of a plurality of figures and IDs, for example, and reads the ID information while referencing the shape of the figure P and the table.

Referring back to FIG. 4, upon reading the ID information, the access right management section 150 of the smartphone 100 changes an access right setting so that an access to the smartphone 100 by the TV 200 identified by the ID is accepted (Step 48).

Then, the content delivery section 160 establishes a connection with the TV 200 using the ID and transmits a content acquisition request to the TV 200 by DLNA Push (Step 49).

Upon reception of the content acquisition request, the content acquisition section 230 of the TV 200 requests the smartphone 100 to deliver a content (Step 50).

The content delivery section 160 of the smartphone 100 reads out a content from the content holding section 140 and transmits the content to the TV 200 (Step 51).

As described above, according to this embodiment, the ID information for identifying the apparatus to be a communication counterpart (TV 200) on the network is displayed as an optical signal (graphic image) on the display section of the apparatus, and the communication-sender apparatus (smartphone 100) photographs the optical signal with the camera 15 so as to read ID information from the optical signal. As a result, the smartphone 100 can specify an apparatus to be a communication counterpart based on the ID information and communicate with that apparatus. Therefore, the user does not need to check the information on the apparatus to be the communication counterpart, such as an IP address, a MAC address, and a model number, and by merely directing the camera 15 to the apparatus to be the communication counterpart, can start communicating with that apparatus.

### Second Embodiment

Next, a second embodiment of the present disclosure will be described. A system of this embodiment has the same structure and functions as those of the first embodiment unless specifically noted otherwise.

### (Outline of System)

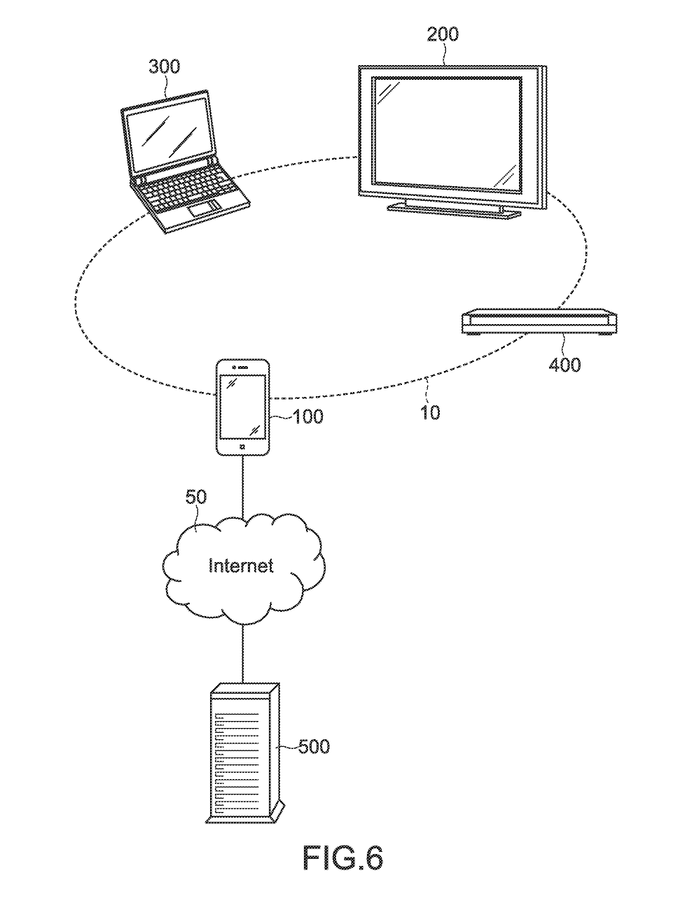

FIG. 6 is a diagram showing an outline of the system according to this embodiment.

As shown in the figure, the system of this embodiment differs from that of the first embodiment in that the smartphone 100 is connected to a server 500 on a cloud via a wide area network such as the Internet 50.

Although descriptions will be given later, the server 500 is capable of acquiring, in response to a request from a communication-sender apparatus such as the smartphone 100, ID information of an apparatus to be a communication counterpart by shape recognition processing and returning the ID information to the communication-sender apparatus.

### (Module Structures of Smartphone, TV, and Server)

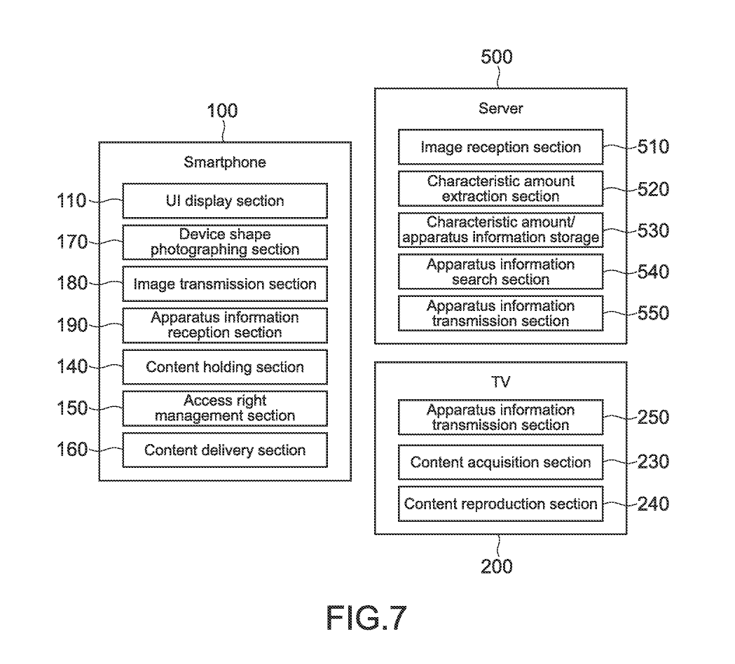

FIG. 7 is a block diagram showing software module structures of the smartphone 100, the TV 200, and the server 500.

### (Modules of Smartphone)

In the first embodiment, the smartphone 100 reads the ID information from the graphic image displayed on the display section of the apparatus to be the communication counterpart. In this embodiment, however, the smartphone 100 acquires ID information based on a shape of an apparatus to be a communication counterpart itself. In this case, the smartphone 100 requests the server 500 to carry out object (shape) recognition processing of the apparatus and receives ID information corresponding to the shape of the apparatus from the server 500.

As shown in the figure, the smartphone 100 includes, in place of the ID display request signal transmission section 120 and the ID information reading section 130 shown in FIG. 3 of the first embodiment, a device shape photographing section 170, an image transmission section 180, and an apparatus information reception section 190.

The device shape photographing section 170 photographs an entire apparatus to be a communication counterpart.

The image transmission section 180 transmits the image taken by the device shape photographing section 170 to the server 500 together with an ID information recognition request.

As a result of the processing carried out in response to the ID information recognition request by the server 500, the apparatus information reception section 190 receives ID information of the apparatus in the image. An example of the ID information in this embodiment is a model number.

### (Modules of Server)

The server 500 includes software modules of an image reception section 510, a characteristic amount extraction section 520, a characteristic amount/apparatus information storage 530, an apparatus information search section 540, and an apparatus information transmission section 550.

The image reception section 510 receives an image transmitted from the image transmission section 180 of the smartphone 100.

The characteristic amount extraction section 520 extracts a characteristic amount from the image received by the image reception section 510. As the characteristic amount, an edge, a corner, and the like are extracted using a well-known technique, for example.

The characteristic amount/apparatus information storage 530 stores, as a table, a predetermined characteristic amount related to the apparatus shape and ID information corresponding thereto.

Referring to the table of the characteristic amount/apparatus information storage 530, the apparatus information search section 540 searches for apparatus information corresponding to the characteristic amount extracted by the characteristic amount extraction section 520.

The apparatus information transmission section 550 returns the apparatus information searched for by the apparatus information search section 540 to the smartphone 100.

### (Modules of TV)

The TV 200 includes an apparatus information transmission section 250 in place of the ID information transmission section 220 as the module shown in FIG. 3 of the first embodiment.

The apparatus information transmission section 250 transmits its own apparatus information (model number information) to the smartphone 100 in response to a request from the smartphone 100.

### (Operation of System)

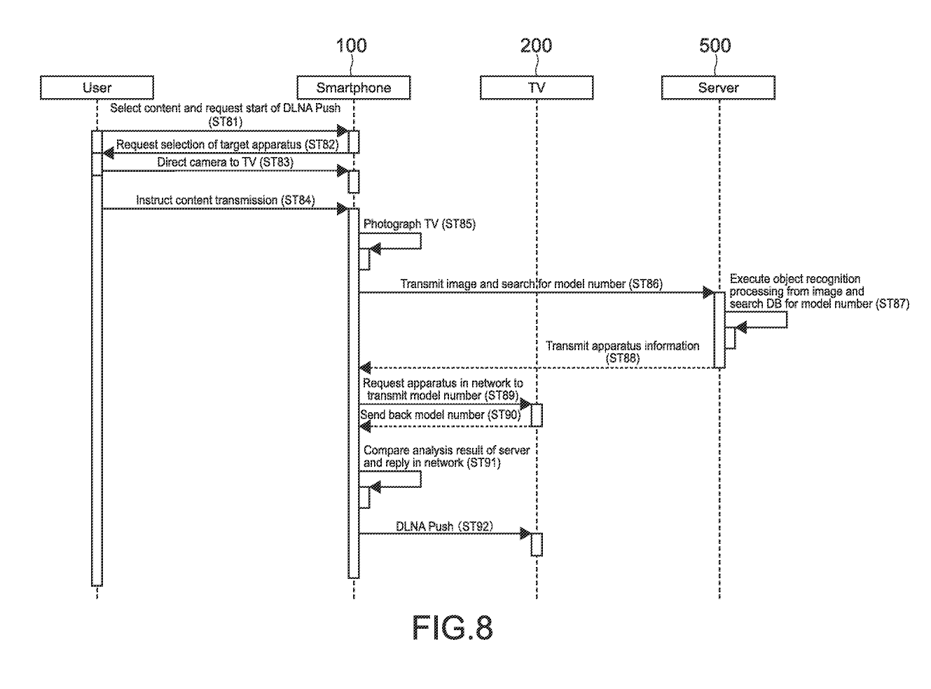

Next, an operation of the system structured as described above will be described. FIG. 8 is a sequence diagram showing a flow of operations of the smartphone 100, the TV 200, and the server 500 in this system. This figure also shows an example where the smartphone 100 establishes a connection with the TV 200 and delivers a specific content stored in itself to the TV 200 by DLNA Push.

First, as in FIG. 4 of the first embodiment, the user of the smartphone 100 inputs operations of selecting a content and requesting a start of DLNA Push via the UI display section 110 (Step 81).

Subsequently, the ID display request signal transmission section 120 of the smartphone 100 displays a screen for prompting the user to select a content delivery target apparatus on the display section 14 (Step 82).

In response to the selection request, the user directs the camera 15 to the TV 200 so that the entire TV 200 is displayed on the display section 14 (Step 83).

Next, upon accepting a content transmission instruction operation of the user with respect to the apparatus displayed on the display section 14 (TV 200) (Step 84), the device shape photographing section 170 photographs the entire TV 200 as a still image (Step 85).

Then, the image transmission section 180 transmits the photographed image of the TV 200 to the server 500 together with an apparatus information (model number) search request (Step 86).

Upon receiving the image, the image reception section 510 of the server 500 hands over the image to the characteristic amount extraction section 520.

Next, the characteristic amount extraction section 520 extracts a characteristic amount from the image. The apparatus information search section 540 searches for apparatus information corresponding to the extracted characteristic amount from the characteristic amount/apparatus information storage 530 (Step 87).

After that, the apparatus information transmission section 550 transmits the apparatus information acquired by the search to the smartphone 100 (Step 88).

Subsequently, upon receiving the transmitted apparatus information, the apparatus information reception section 190 of the smartphone 100 requests the apparatus in the home network 10 to transmit the apparatus information (model number) by broadcast (Step 89). The apparatus information request is executed by a “GetDeviceInfo” command defined in DLNA, for example.

In response to the apparatus information request, the apparatus information transmission section 250 of the TV 200 (and other apparatuses) returns its own apparatus information (e.g., model number and manufacturer) by a “ReplyDeviceInfo” command defined in DLNA, for example (Step 90).

The apparatus information reception section 190 of the smartphone 100 compares the apparatus information received from the server 500 and the apparatus information returned from the apparatus in the home network 10 and specifies which apparatus is the apparatus photographed by the camera 15 (Step 91). Since the apparatus information received from the server 500 and the apparatus information received from the TV 200 match in the figure, the TV 200 is specified as the photographed apparatus.

Then, the content delivery section 160 delivers a content to the TV 200 as the specified apparatus by DLNA Push using the model number information or the like as an ID on the network (Step 92).

As described above, according to this embodiment, the smartphone 100 is capable of comparing the apparatus information received from the server 500 as a result of the shape recognition processing and the local apparatus information collected by itself to specify the apparatus information of the TV 200 as ID information on the home network 10 and delivering a content to the TV 200.

### Third Embodiment

Next, a third embodiment of the present disclosure will be described. A system of this embodiment has the same structure and functions as those of the first embodiment unless specifically noted otherwise.

In the first and second embodiments above, the smartphone 100 delivers, as the DMS of DLNA, its own content to the TV 200 as the DMP. However, the smartphone 100 may function as the DMC as described above. For example, as the DMC, the smartphone 100 can cause the TV 200 as the DMP to reproduce a content stored in the BD recorder 400 as the DMS.

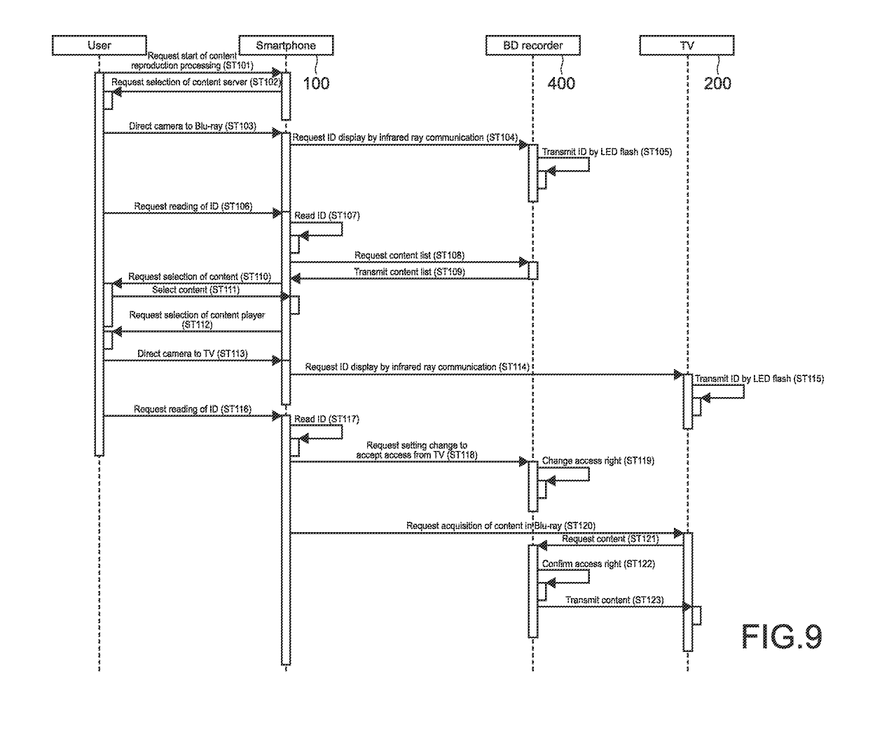

FIG. 9 is a sequence diagram showing a flow of operations of the smartphone 100, the PD recorder 400, and the TV 200 in a case where content reproduction processing as described above is executed.

As shown in the figure, the ID display request signal transmission section 120 of the smartphone 100 first accepts an operation for a content reproduction processing start request from the user (Step 101), and then displays a UI (e.g., message) for prompting the user to select a content server (apparatus to deliver content) (Step 102).

In response to the selection request, the user directs the camera 15 to the BD recorder 400 so that the BD recorder 400 is displayed on the display section 14 (Step 103). At this time, as the UI of the display section 14, an interface for confirming the user whether the selection processing has been completed in response to the selection request (e.g., OK/cancel button) is displayed and upon directing the camera to the BD recorder 400, presses the OK button.

Upon completing the selection of the apparatus, the ID display request signal transmission section 120 transmits an ID display request signal to the BD recorder 400 by infrared ray communication (Step 104).

The ID display request signal reception section 210 of the BD recorder 400 receives the ID display request signal from the smartphone 100 and hands it over to the ID information transmission section 220. The ID information transmission section 220 causes, for example, an LED (Light Emitting Diode) display section provided on a front surface of the BD recorder 400 to flash as an expression of the ID information (Step 105).

Here, when the selected apparatus includes a display section, a predetermined flash pattern may be displayed on the display section instead of the flash processing of the LED display section.

Further, the flash pattern may be emitted as infrared light, and a light-receiving section (e.g., camera 15) of an apparatus that reads an ID (smartphone 100) may have a function of reading infrared light. Also in this case, the light-receiving section does not need to be a camera and may be a light-receiving device capable of reading only a signal intensity. By emitting the ID as infrared light, the light does not touch an eye of the user as compared to the case of emitting visible light, which can thus prevent the user from feeling uncomfortable or vexatious.

Subsequently, the user that has directed the camera 15 to the BD recorder 400 inputs an ID reading instruction operation via the UI display section 110 (Step 106). In response to the operation, the ID information reading section 130 of the smartphone 100 reads ID information from the flash pattern (Step 107). Here, the ID information reading section 130 may read the ID information without waiting for the ID reading instruction in Step 106.

Next, the content delivery section 160 of the smartphone 100 requests the BD recorder 400 to transmit a list of contents stored in the BD recorder 400 (Step 108).

In response to the list request, the BD recorder 400 returns the list of contents stored in itself to the smartphone 100 (Step 109).

Then, the UI display section 110 of the smartphone 100 displays a UI (e.g., message) for prompting the user to select any of the contents on the list displayed on the display section 14 (Step 110).

After that, the UI display section 110 accepts an operation of selecting a content from the user (Step 111).

Subsequently, the ID display request signal transmission section 120 displays a UI (e.g., message) for prompting the user to select a content player (apparatus to reproduce content) (Step 112).

In response to the selection request, the user directs the camera 15 to the TV 200 so that the TV 200 is displayed on the display section 14 (Step 113).

After that, the ID information of the TV 200 is read by the same steps as Steps 104 to 107 (Steps 114 to 117).

Next, the content delivery section 160 of the smartphone 100 transmits an access right setting change request to the BD recorder 400 so that an access from the TV 200 to the BD recorder 400 is accepted (Step 118). The ID information of the BD recorder 400 is used in transmitting the request, and the request also includes the ID information of the TV 200.

In response to the access right setting change request, the BD recorder 400 changes the access right setting so as to accept the access from the TV 200 (Step 119).

Next, the content delivery section 160 of the smartphone 100 requests the TV 200 to access the BD recorder 400 and acquire the content selected by the user out of the stored contents (Step 120).

In response to the acquisition request, the content acquisition section 230 of the TV 200 requests the BD recorder 400 to deliver the content (Step 121).

In response to the content delivery request, the BD recorder 400 transmits the requested content to the TV 200 after confirming that the TV 200 has an access right with respect to the BD recorder 400 (Step 122) (Step 123).

As described above, according to this embodiment, the smartphone 100 as the DMC can sequentially photograph the BD recorder 400 as the DMS and the TV 200 as the DMP to acquire ID information thereof and change the access right setting of the BD recorder 400 so as to accept the access from the TV 200.

### Fourth Embodiment

Next, a fourth embodiment of the present disclosure will be described. A system of this embodiment has the same structure and functions as those of the third embodiment unless specifically noted otherwise.

In the third embodiment, the change of an access right from the TV 200 to the BD recorder 400 is managed by the BD recorder 400 itself, and the smartphone 100 requests the BD recorder 400 to change the access right setting. In this embodiment, however, the access right is managed by the server 500 on a cloud together with access rights among other apparatuses. Therefore, the smartphone 100 requests the server 500 to change the access right setting.

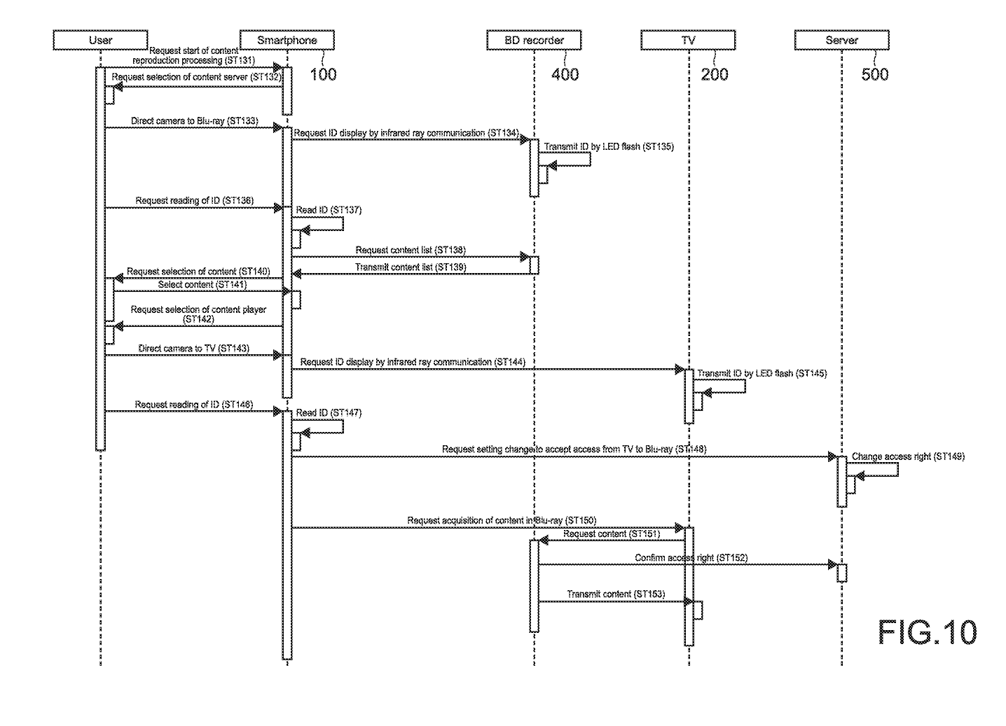

FIG. 10 is a sequence diagram showing a flow of operations of the smartphone 100, the BD recorder 400, the TV 200, and the server 500 in a case where content reproduction processing is executed in this embodiment.

As shown in the figure, the processes from Steps 131 to 147 are the same as those of Steps 101 to 117 of FIG. 9 according to the third embodiment.

Upon acquiring ID information from the BD recorder 400 and the TV 200, the content delivery section 160 of the smartphone 100 transmits an access right setting change request to the server 500 so as to accept an access from the TV 200 to the BD recorder 400 (Step 148). This request includes the ID information of the BD recorder 400 and the TV 200.

Upon receiving the access right setting change request, the server 500 changes the access right setting so as to accept the access from the TV 200 to the BD recorder 400 (Step 149).

The processes after that are the same as those of Steps 120 to 123 of FIG. 9 according to the third embodiment (Steps 150 to 153).

As described above, according to this embodiment, the smartphone 100 as the DMC can sequentially photograph the BD recorder 400 as the DMS and the TV 200 as the DMP to acquire ID information thereof and change the setting of the server 500 to accept the access between the apparatuses.

### MODIFIED EXAMPLE

The present disclosure is not limited to the embodiments above and can be variously modified without departing from the gist of the present disclosure.

### Modified Example 1

The ID of each apparatus is displayed on the display section of the apparatus as a graphic image in the first embodiment, recognized as the shape of the apparatus itself in the second embodiment, and transmitted as the LED flash pattern in the third and fourth embodiments. However, the form of IDs is not limited to those described above. In other words, the ID may be expressed in any form as long as it is emitted as an optical signal from the apparatuses.

For example, the ID may be attached to a casing of each apparatus in a form of a sticker on which a figure, a pattern, a letter, and the like are printed like a QR code.

Further, the ID may be a watermark inserted into a video signal. In this case, an apparatus that issues an ID may transmit the video signal into which the watermark has been inserted to an apparatus that reads the ID via the home network 10, for example.

Furthermore, the ID may constantly be illuminated (in readable state) like the sticker or the shape of the apparatus itself, or may be displayed on an apparatus to be a communication counterpart only when a display request is transmitted via the LAN or using infrared rays (remote controller) as described in the embodiments above. Moreover, a physical button may be provided to the apparatus to be a communication counterpart so that the ID is displayed on the display section or the like or emitted as a flash pattern only when the button is pressed by the user, and the apparatus that reads the ID may execute the ID reading processing based on that ID.

### Modified Example 2

In the second embodiment, the ID information of the apparatus to be a communication counterpart is acquired based on the entire image of the apparatus. However, instead of the entire image of the apparatus, the ID information may be acquired based on a partial image (e.g., shape of characteristic part).

### Modified Example 3

In the first to fourth embodiments above, the optical signal received by the camera 15 or the like is emitted from a single apparatus. However, in some cases, a plurality of apparatuses may exist within a photographing range of the camera 15. In such a case, the smartphone 100 may display a message that prompts the user to select, as an apparatus to be a communication counterpart, any of the images of the plurality of apparatuses displayed on the display section 14 by a touch operation, for example. The smartphone 100 may read the ID information from the optical signal emitted from the selected apparatus. However, when the user wishes to communicate with a plurality of apparatuses, the ID information may be read from optical signals emitted from those apparatuses. In this case, the selection request message only needs to provide a choice for setting the plurality of apparatuses as communication counterparts.

### Modified Example 4

In the second embodiment above, the apparatus shape recognition processing is carried out by the server 500 based on the request from the smartphone 100. However, the processing may be carried out by the smartphone 100. In this case, the smartphone 100 only needs to be provided with software modules that are the same as those of the server 500 shown in FIG. 7.

### Modified Example 5

The first to fourth embodiments above show the examples where the present disclosure is applied on DLNA. However, the present disclosure may be applied on a network conforming to standards other than DLNA.

### Modified Example 6

The first to fourth embodiments above show the examples where a smartphone is used as the apparatus that reads ID information. However, the apparatus is of course not limited to the smartphone, and the present disclosure can be similarly applied as long as the apparatus is an information processing apparatus including a camera or a light-receiving device, such as a digital still camera, a digital video camera, a portable game device, and a tablet PC.

### (Others)

The present disclosure may also take the following structures.

(1) An information processing apparatus, including:

a light-receiving section capable of receiving an optical signal emitted from another apparatus;

a controller capable of acquiring identification information for identifying the another apparatus on a network based on the received optical signal; and

a communication section capable of establishing a connection with the another apparatus based on the acquired identification information.

(2) The information processing apparatus according to (1) above,

in which the light-receiving section is capable of photographing the another apparatus,

the information processing apparatus further including a display section capable of displaying an image of the photographed another apparatus, and

in which the controller is capable of acquiring the identification information when the image of the another apparatus is displayed on the display section.

(3) The information processing apparatus according to (1) or (2) above,

in which the another apparatus is capable of displaying a predetermined image corresponding to the identification information as the optical signal,

in which the light-receiving section is capable of photographing the image, and

in which the controller is capable of acquiring the identification information from the photographed image.

(4) The information processing apparatus according to (1) or (2) above,

in which the light-receiving section is capable of receiving at least a part of the image of the another apparatus as the optical signal, and

in which the controller is capable of acquiring the identification information of the another apparatus based on a result of object recognition processing carried out on the part of the image of the another apparatus.

(5) The information processing apparatus according to any one of (1) to (4) above, further including

a transmission section capable of transmitting a request signal for requesting the another apparatus to emit the optical signal.

(6) The information processing apparatus according to any one of (2) to (5) above, further including

an operation reception section capable of receiving, when a plurality of images of the another apparatus are displayed on the display section, an operation of selecting any one the plurality of images,

in which the controller is capable of acquiring the identification information of an apparatus corresponding to the image selected by the operation.

(7) The information processing apparatus according to any one of (1) to (6) above, further including

a storage that stores a content,

in which the controller is capable of controlling the communication section to transmit the content to the another apparatus with which the connection has been established.

(8) The information processing apparatus according to any one of (1) to (7) above,

in which the light-receiving section is capable of receiving a first optical signal emitted from a first apparatus and a second optical signal emitted from a second apparatus different from the first apparatus,

in which the controller is capable of acquiring first identification information of the first apparatus based on the first optical signal and second identification information of the second apparatus based on the second optical signal, and

in which the communication section is capable of establishing a connection with the first apparatus based on the first identification information and a connection with the second apparatus based on the second identification information, and transmitting a setting change request to change an access setting between the first apparatus and the second apparatus to one of the first apparatus and the second apparatus.

(9) The information processing apparatus according to any one of (1) to (7) above,

in which the light-receiving section is capable of receiving a first optical signal emitted from a first apparatus and a second optical signal emitted from a second apparatus different from the first apparatus,

in which the controller is capable of acquiring first identification information of the first apparatus based on the first optical signal and second identification information of the second apparatus based on the second optical signal, and

in which the communication section is capable of establishing a connection with the first apparatus based on the first identification information and a connection with the second apparatus based on the second identification information, and transmitting a setting change request to change an access setting between the first apparatus and the second apparatus to a server on the network that manages the access setting.

(10) The information processing apparatus according to any one of (1) to (9) above,

in which the optical signal is emitted as infrared light, and

in which the light-receiving section is capable of receiving the infrared light.

The present disclosure contains subject matter related to that disclosed in Japanese Priority Patent Application JP 2012-194991 filed in the Japan Patent Office on Sep. 5, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a light-receiving section capable of receiving an optical signal emitted from another apparatus;
a controller capable of acquiring identification information for identifying the another apparatus on a network based on the received optical signal; and
a communication section capable of establishing a connection with the another apparatus based on the acquired identification information.

2. The information processing apparatus according to claim 1,
wherein the light-receiving section is capable of photographing the another apparatus,
the information processing apparatus further comprising a display section capable of displaying a photographed image of the another apparatus, and
wherein the controller is capable of acquiring the identification information when the image of the another apparatus is displayed on the display section.

3. The information processing apparatus according to claim 2,
wherein the another apparatus is capable of displaying a predetermined image corresponding to the identification information as the optical signal,
wherein the light-receiving section is capable of photographing the image, and
wherein the controller is capable of acquiring the identification information from the photographed image.

4. The information processing apparatus according to claim 2,
wherein the light-receiving section is capable of receiving at least a part of the image of the another apparatus as the optical signal, and
wherein the controller is capable of acquiring the identification information of the another apparatus based on a result of object recognition processing carried out on at least the part of the image of the another apparatus.

5. The information processing apparatus according to claim 1, further comprising
a transmission section capable of transmitting a request signal for requesting the another apparatus to emit the optical signal.

6. The information processing apparatus according to claim 2, further comprising
an operation reception section capable of receiving, when images of a plurality of another apparatuses are displayed on the display section, an operation of selecting any one of the images of the plurality of another apparatuses,
wherein the controller is capable of acquiring the identification information of an apparatus corresponding to the image selected by the operation.

7. The information processing apparatus according to claim 1, further comprising
a storage that stores a content,
wherein the controller is capable of controlling the communication section to transmit the content to the another apparatus with which the connection has been established.

8. The information processing apparatus according to claim 1,
wherein the light-receiving section is capable of receiving a first optical signal emitted from a first apparatus and a second optical signal emitted from a second apparatus different from the first apparatus,
wherein the controller is capable of acquiring first identification information of the first apparatus based on the first optical signal and second identification information of the second apparatus based on the second optical signal, and
wherein the communication section is capable of establishing a connection with the first apparatus based on the first identification information and a connection with the second apparatus based on the second identification information, and transmitting a setting change request to change an access setting between the first apparatus and the second apparatus to one of the first apparatus and the second apparatus.

9. The information processing apparatus according to claim 1,
wherein the light-receiving section is capable of receiving a first optical signal emitted from a first apparatus and a second optical signal emitted from a second apparatus different from the first apparatus,
wherein the controller is capable of acquiring first identification information of the first apparatus based on the first optical signal and second identification information of the second apparatus based on the second optical signal, and
wherein the communication section is capable of establishing a connection with the first apparatus based on the first identification information and a connection with the second apparatus based on the second identification information, and transmitting a setting change request to change an access setting between the first apparatus and the second apparatus to a server on the network that manages the access setting.

10. The information processing apparatus according to claim 1,
wherein the optical signal is emitted as infrared light, and
wherein the light-receiving section is capable of receiving the infrared light.

11. An information processing system, comprising:
a first apparatus; and
a second apparatus,
the first apparatus including
a light-receiving section capable of receiving an optical signal emitted from the second apparatus,
a controller capable of acquiring identification information for identifying the second apparatus on a network based on the received optical signal, and
a first communication section capable of transmitting a connection establishment request to the second apparatus based on the acquired identification information,
the second apparatus including
a light-emitting section that emits the optical signal, and
a second communication section capable of establishing a connection with the first apparatus in response to the transmitted connection establishment request.

12. An information processing method, comprising:
receiving an optical signal emitted from another apparatus;
acquiring identification information for identifying the another apparatus on a network based on the received optical signal; and
establishing a connection with the another apparatus based on the acquired identification information.

13. A program that causes an information processing apparatus to execute the steps of:
receiving an optical signal emitted from another apparatus;
acquiring identification information for identifying the another apparatus on a network based on the received optical signal; and
establishing a connection with the another apparatus based on the acquired identification information.
